(19) United States
(12) Patent Application Publication
(10) Pub. No.: US 2017/0076085 A1
(43) Pub. Date: Mar. 16, 2017

(54) INSTRUMENT CONTROL SYSTEM, INSTRUMENT CONTROL DEVICE, INSTRUMENT CONTROL METHOD, AND NON-TRANSITORY COMPUTER READABLE RECORDING MEDIUM RECORDED WITH PROGRAM

(71) Applicant: Mitsubishi Electric Corporation, Tokyo (JP)

(72) Inventor: Akihiro MIURA, Tokyo (JP)

(73) Assignee: Mitsubishi Electric Corporation, Tokyo (JP)

(21) Appl. No.: 15/123,176

(22) PCT Filed: May 29, 2014
(86) PCT No.: PCT/JP2014/064234

§ 371 Date: Sep. 1, 2016

(51) Int. Cl. G06F 21/44

(52) U.S. Cl. CPC G06F 21/44

(57) ABSTRACT

An authentication setting device includes an authentication setting unit to transmit a setting request requesting setting of instrument authentication information. An authentication execution device includes: an authentication information generation unit which, upon reception of the setting request, sets instrument authentication information; an authentication unit which, upon acquisition of an authentication request, outputs a collection request requesting collection of instrument attribute information; and a collection unit which, upon acquisition of the collection request, collects instrument attribute information of the time the collection request is acquired, and outputs the collected instrument attribute information. The authentication unit acquires the instrument attribute information outputted from the collection unit, as authentication-use instrument attribute information, authenticates the instrument based on the acquired authentication-use instrument attribute information and the instrument authentication information, and decides whether or not authentication of the instrument is successful.

### TECHNICAL FIELD

The present invention relates to an instrument control system, an instrument control device, an instrument control method, and a program.

### BACKGROUND ART

A service provider of an information communication service needs to build an appropriate module into a device, set the module appropriately, and check that the module is in a normal state, for the sake of security and reliability of the device and service. These needs are aimed at securely providing mobile telephone services and information communication services such as contents distribution.

As a device management technique that copes with such needs, a method is available that compares a security policy which is set based on device configuration information and service subscriber information, with a module state acquired from the device, and makes diagnosis as to whether the module being necessary for the device configuration operates under correct setup (see Patent Literature 1, for example).

The device configuration information is, for example, device identifier, operating system, or the network to connect to. The service subscriber information is, for example, subscriber identifier, subscribed service type, or subscribed service setup. The module acquired from the device is, for example, computer virus search, tampering detection, or firewall.

As a device authentication technique to authenticate a device which is to be connected to an FA (Factory Automation) controller such as PLC (Programmable Logic Controller), a method as follows is available (see Patent Literature 2, for example). A management terminal adds a manufacturer signature to information of this device using a manufacturer secret key, thus forming configuration data. The management terminal transmits this configuration data and a manufacturer certificate to the FA controller. The FA controller verifies the configuration data using the manufacturer certificate. If verification is successful, the signature is added to the configuration data using a key in a TPM (Trusted Platform Module), and the configuration data is stored in the FA controller together with the manufacturer certificate. When the device is connected to the FA controller, an encrypted instrument authentication program is decrypted using the key. The connected device is verified. The stored configuration data is verified by the manufacturer signature. The information obtained from the connected device and the configuration data are compared, so that the FA controller can authenticate on its own the identity and authenticity of each device connected to the FA controller, and the configuration of each connected device.

### CITATION LIST

### Patent Literature

Patent Literature 1: JP 2006-155583
Patent Literature 2: JP2010-182070

### SUMMARY OF INVENTION

### Technical Problem

The device management technique disclosed in Patent Literature 1 has a problem that it merely checks the setup information of the software installed in the device and cannot confirm the connection statuses of other instruments connected to the device. The connection statuses include the connection numbers in sequence of the other instruments connected to the device.

In a control system having a combination of a plurality of instruments such as a power supply, a PLC, and an input/output instrument that serve to control plant production facilities, memory addresses that can be used are decided according to the connection numbers in sequence of the instruments. For this reason, when the configuration information is to be checked by comparison, it is required to authenticate that the configuration (model numbers and pieces of information that allow identification of the individual instruments) of the device is identical, including the connection numbers in sequence of the instruments, as the configuration of the time the device manufacturer had delivered the device to the end user.

With the device authentication technique disclosed in Patent Literature 2, the authenticity of the connected instruments can be checked by comparing configuration data with information obtained from instruments connected to a PLC. However, there is a problem that with this technique, it is difficult to check the connection numbers in sequence of the instruments. Also, since the instruments are usually used at locations remote from the instrument management device, the instrument management device cannot verify whether the instrument module information reflect the actual configuration.

The present invention has been made to solve the above problems, and has as its object to provide an authentication management system that accurately authenticates instruments connected to the control system, even from a remote location, so that arbitrary alteration of the instrument configuration and the like can be prevented.

### Solution to Problem

An instrument control system according to the present invention is an instrument control system including an instrument control device to control an instrument, and a terminal device to communicate with the instrument control device,

the terminal device having a setting request unit to transmit a setting request requesting setting of instrument authentication information used for authentication of the instrument,

the instrument control device having:

an information setting unit to set, upon reception of the setting request from the setting request unit, the instrument authentication information to a storage device;

an authentication unit to acquire an authentication request requesting authentication of the instrument, and in response to the acquired authentication request, output a collection request requesting collection of instrument attribute information indicating an attribute of the instrument; and

a collection unit to collect, upon acquisition of the collection request, instrument attribute information indicating an attribute of the instrument of the time the collection request is acquired, and output the collected instrument attribute information,

the authentication unit acquiring the instrument attribute information outputted from the collection unit, as authentication-use instrument attribute information used for authentication of the instrument, authenticating the instrument based on the acquired authentication-use instrument attribute information and the instrument authentication information which is set by the information setting unit, and deciding whether or not authentication of the instrument is successful.

### Advantageous Effects of Invention

In an instrument control system according to the present invention, a terminal device has a setting request unit to transmit a setting request requesting setting of instrument authentication information used for authentication of the instrument. An instrument control device has: an information setting unit to set, upon reception of the setting request, the instrument authentication information; an authentication unit to output, upon acquisition of an authentication request requesting authentication of the instrument, a collection request requesting collection of instrument attribute information indicating an attribute of the instrument; and a collection unit to collect, upon acquisition of the collection request, instrument attribute information indicating an attribute of the instrument of the time the collection request is acquired, and output the collected instrument attribute information. The authentication unit acquires the instrument attribute information outputted from the collection unit, as authentication-use instrument attribute information used for authentication of the instrument, authenticates the instrument based on the acquired authentication-use instrument attribute information and the instrument authentication information which is set by the information setting unit, and decides whether or not authentication of the instrument is successful. Therefore, instruments connected to the instrument control device can be authenticated, even from a location remote from the instrument control device, and whether or not the instrument attribute has been altered can be decided reliably.

### BRIEF DESCRIPTION OF DRAWINGS

FIG. 1 is a diagram illustrating an example of a block configuration of an authentication management device 100 according to Embodiment 1.

FIG. 2 is a diagram illustrating an example of a hardware configuration of an authentication setting device 200 and an authentication execution device 300 according to an embodiment.

FIG. 3 is a diagram illustrating an example of a control system 500 and configuration information 510 according to an embodiment.

FIG. 4 is a diagram illustrating an example of log information 520 being an instrument authentication result of an instrument authentication process which is executed by an authentication management device 100 according to an embodiment.

FIG. 5 is a flowchart illustrating an operation of an instrument authentication setting method (process, stage) in an authentication management device 100 according to an embodiment.

FIG. 6 is a flowchart illustrating an operation of an instrument authentication process (stage) in an authentication management method according to an embodiment.

FIG. 7 is a flowchart illustrating an operation of a resetting process (stage) for instrument authentication information in an authentication management method according to an embodiment.

FIG. 8 is a diagram explaining a case where an output instrument in a control system 500 (device) according to an embodiment is exchanged (replaced) by an output instrument having the same model number but different inherent information.

FIG. 9 is a diagram illustrating log information 520 in an authentication management device 100 according to an embodiment, in which (a) presents an example of log information 520a of before resetting of instrument authentication information is practiced, and (b) presents an example of log information 520b of after resetting of instrument authentication information is practiced.

FIG. 10 is a diagram illustrating an example of a block configuration of an authentication management device according to Embodiment 2.

FIG. 11 is a diagram illustrating an example of a block configuration of an authentication management device according to Embodiment 3.

FIG. 12 is a diagram illustrating an example of a block configuration of an authentication management device according to Embodiment 4.

### DESCRIPTION OF EMBODIMENTS

### Embodiment 1

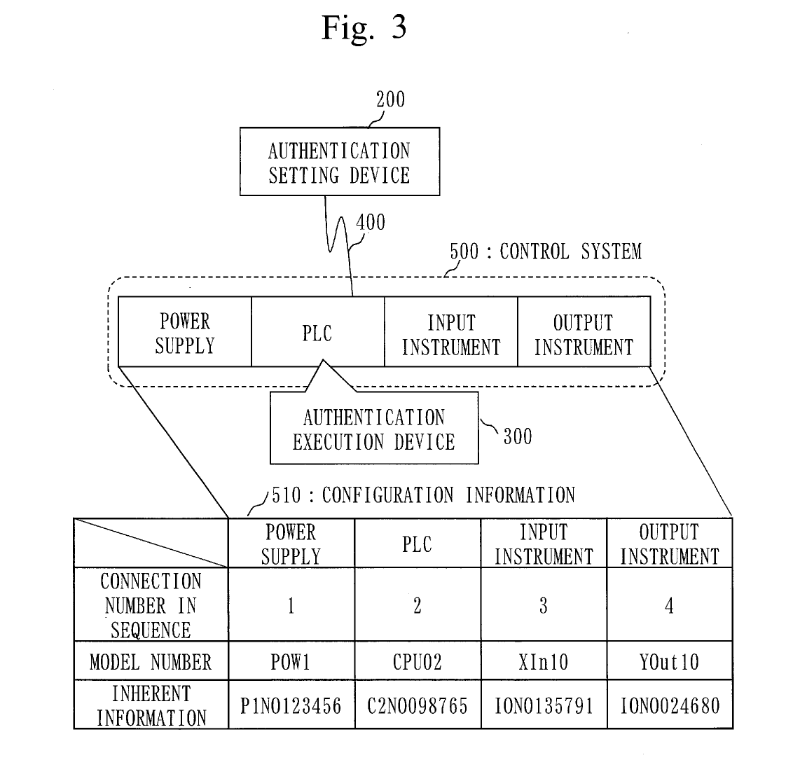

This embodiment will describe an authentication management device 100 which authenticates constituent products such as instruments connected in a control system 500 (see FIG. 3). The control system 500 is a system having a combination of a plurality of instruments such as a power supply, a PLC, and an input/output instrument that serve to control plant production facilities (for example, a robot, motor, or processing machinery).

The control system 500 includes a PLC that controls the instruments. The PLC controls the instruments connected to it and authenticates these instruments.

Sometimes, after the control system 500 manufactured by a device manufacturer was delivered to the end user having a plant, the end user may alter the configuration of instruments connected to the PLC arbitrary, and use the control system 500 with the altered instrument configuration. In this embodiment, the authentication management device 100 will be described which has a function of preventing such arbitrary alteration of the instrument configuration.

The device manufacturer of the control system 500 is an example of the user of the authentication management device 100.

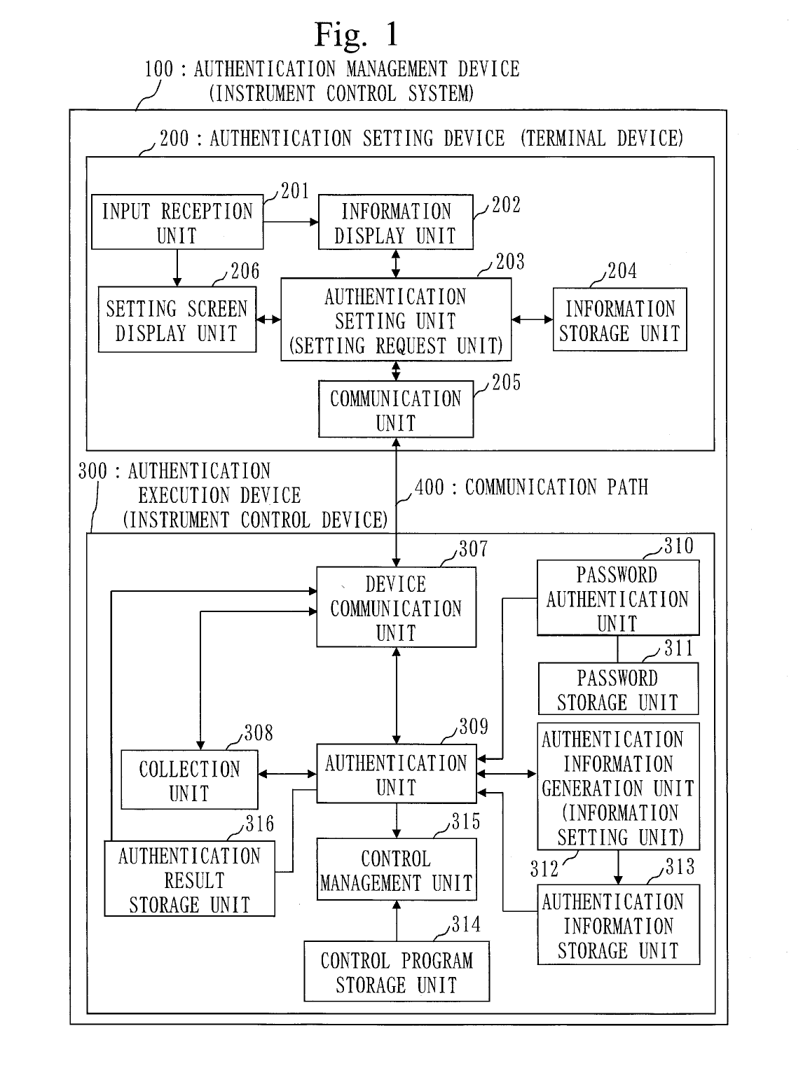

FIG. 1 is a diagram illustrating an example of a block configuration of the authentication management device 100 according to this embodiment.

The authentication management device 100 according to this embodiment includes an authentication setting device 200 and an authentication execution device 300.

The authentication setting device 200 and the authentication execution device 300 are connected to each other via a communication path 400. The communication path 400 is, for example, a USB cable, a network, or the like.

The authentication management device 100 including the authentication setting device 200 and authentication execution device 300 is sometimes called an authentication management system or an instrument control system.

The authentication setting device 200 is incorporated in, for example, a PC (Personal Computer). The authentication setting device 200 is an example of a terminal device.

The authentication execution device 300 is incorporated in, for example, a PLC. The authentication execution device 300 is an example of an instrument control device.

The authentication setting device 200 is a management terminal which displays configuration information 510 (see FIG. 3) of the control system 500, on a display device and accepts an operation instruction from the user. The configuration information 510 of the control system 500 is instrument attribute information indicating the attribute of the instrument connected to the PLC. A practical example of the instrument attribute information will be described later.

The authentication setting device 200 transmits to the authentication execution device 300 a confirmation request requesting confirmation of the configuration information 510 indicating the attributes of the instruments of the control system 500. The authentication setting device 200 also transmits to the authentication execution device 300 a setting request requesting setting of the instrument authentication information used for constituent product authentication (to be sometimes referred to as instrument authentication hereinafter). In response to these requests, the configuration information 510 of the instruments connected to the PLC are collected and held, and it is confirmed that the configuration information 510 has not been altered in an initial process executed at the time the power supply of the PLC is turned on.

As described above, the authentication execution device 300 is incorporated in the PLC of the control system 500. The authentication execution device 300 may be software (middleware) which operates on the PLC. The authentication execution device 300 authenticates the configuration of the instruments constituting the control system 500, while considering the connection numbers in sequence, and stores an authentication result to a storage device as log information.

The authentication setting device 200 includes an input reception unit 201, an information display unit 202, an authentication setting unit 203, an information storage unit 204, a communication unit 205, and a setting screen display unit 206.

The input reception unit 201 accepts a display instruction for the configuration information 510, a password setting instruction, and the like entered by the user with a mouse, a keyboard, or the like.

The information display unit 202 displays the configuration information 510 such as the model numbers of instruments (such as a power supply and an input/output instrument) connected to the PLC, inherent information such as manufacture numbers that allow identification of the instruments individually, and the connection numbers in sequence of the instruments. The information display unit 202 also displays the configuration information 510 stored in the information storage unit 204 (to be described later).

The authentication setting unit 203 checks whether or not the PC that executes the authentication setting device 200 is connected to the control system 500. The authentication setting unit 203 transmits a setting confirmation request to the control system 500, and receives a response to the transmitted setting confirmation request, to check whether or not the PC is connected to the control system 500.

The authentication setting unit 203 also transmits a setting request requesting setting of instrument authentication information used for instrument authentication. The authentication setting unit 203 also transmits a confirmation request requesting confirmation of the instrument. The authentication setting unit 203 is an example of a setting request unit.

After the instrument authentication information is set in the authentication execution device 300, the information storage unit 204 stores instrument authentication information (configuration information 510) transmitted from the authentication execution device 300, to the storage device. Thus, the instrument authentication information can be checked in the authentication setting device 200 after it is set in the authentication execution device 300.

The instrument authentication information is the configuration information 510 which is decided by the device manufacturer as indicating regular configuration of the instruments connected to the PLC.

The communication unit 205 executes transfer of data such as the confirmation request for the configuration information 510 and a confirmation response to the confirmation request, between the authentication setting device 200 and the PLC of the control system 500, via the communication path 400.

The setting screen display unit 206 displays on the display device a password setting screen to set a password necessary to discriminate whether the user has the privilege to execute update of the instrument authentication information which is set in the PLC. If an instrument (an instrument connected to the PLC) constitutive of the control system 500 has trouble, the user exchanges the failed instrument, and then updates the instrument authentication information which has been set in the PLC. The setting screen display unit 206 allows the user to set, using the input reception unit 201, a password authentication-use password necessary to discriminate whether the user who tries to execute update has the privilege to execute update of the instrument authentication information.

The authentication execution device 300 includes a device communication unit 307, a collection unit 308, an authentication unit 309, a password authentication unit 310, a password storage unit 311, an authentication information generation unit 312, an authentication information storage unit 313, a control program storage unit 314, a control management unit 315, and an authentication result storage unit 316.

The device communication unit 307 receives the request from the communication unit 205 of the authentication setting device 200, interprets the content of the received request, and executes transfer of data such as the configuration information 510, to the authentication setting device 200.

After acquiring a collection request, the collection unit 308 collects the configuration information 510 such as model numbers, pieces of inherent information that allow individual identification, and connection numbers in sequence, from the instruments connected to the PLC.

As described above, the configuration information 510 is instrument attribute information indicating the attribute of the instrument connected to the PLC. The instrument includes a plurality of instruments such as the power supply and the input/output instrument. The instrument attribute information includes, for example, the connection numbers in sequence, as connection information in accordance with which the plurality of instruments are connected to the PLC. The instrument attribute information also includes pieces of inherent information that allow identification of the plurality of instruments individually, as instrument identification information.

In the initial process executed at the time the power supply of the PLC is turned on, the authentication unit 309 executes an instrument authentication for checking whether the configuration of the instruments connected to the PLC is correct.

The password authentication unit 310 executes password authentication of a preset authentication-use password. This password authentication is aimed at permitting update of the instrument authentication information in cases where, for example, a failed instrument is exchanged, only when authentication by the authentication-use password is successful.

The password storage unit 311 stores in the storage device the authentication-use password which has been set on the setting screen display unit 206 by the user using the input reception unit 201. The password storage unit 311 stores the authentication-use password which has been irreversibly converted (for example, hashed) by the authentication unit 309.

When the authentication execution device 300 receives a setting request, the authentication unit 309 outputs a collection request requesting the collection unit 308 to collect the configuration information 510 of the time the setting request is received, as the instrument attribute information. When the collection unit 308 acquires the collection request, it collects the instrument attribute information and outputs it. The authentication unit 309 outputs the outputted instrument attribute information to the authentication information generation unit 312 as authentication-use instrument attribute information to be used for authentication of the instrument, and causes the authentication information generation unit 312 to set the authentication-use instrument attribute information into the storage device as the instrument authentication information.

The authentication information generation unit 312, instead of storing the configuration information 510 (authentication-use instrument attribute information) collected by the collection unit 308 into the storage device in the form of a plaintext, encrypts or irreversibly converts the configuration information 510 partly or entirely. The authentication information generation unit 312 generates the instrument authentication information 512 by encrypting the authentication-use instrument attribute information (configuration information 510).

The authentication information storage unit 313 stores the instrument authentication information 512 generated by the authentication information generation unit 312, to the storage device.

When the authentication execution device 300 receives an authentication request, the authentication unit 309 conducts instrument authentication based on the instrument authentication information and the authentication-use instrument attribute information which has been collected by the collection unit 308, and decides whether the instrument authentication is successful or not.

The control program storage unit 314 stores a program (for example, a ladder program) used for controlling the instrument.

Based on the authentication result of the authentication unit 309, the control management unit 315 executes the control program stored in the control program storage unit 314. If the authentication unit 309 decides that the instrument authentication fails, the control management unit 315 stops control for the instrument.

The authentication result storage unit 316 stores the result of authentication in the authentication unit 309 to the storage device.

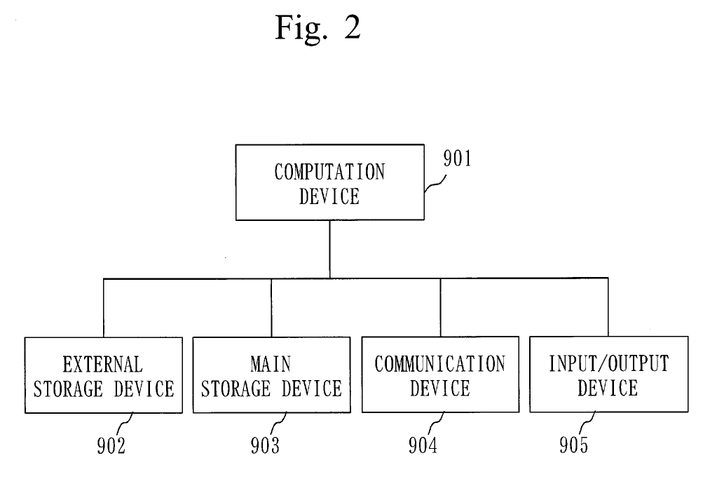

FIG. 2 is a diagram illustrating an example of a hardware configuration of the authentication setting device 200 and authentication execution device 300 according to this embodiment.

A hardware configuration example of the authentication setting device 200 and authentication execution device 300 will be described with reference to FIG. 2.

Each of the authentication setting device 200 and the authentication execution device 300 is a computer. The elements of the authentication setting device 200 and the authentication execution device 300 can be implemented by a program.

The hardware configuration of each of the authentication setting device 200 and the authentication execution device 300 includes a computation device 901, an external storage device 902, a main storage device 903, a communication device 904, and an input/output device 905 that are connected to a bus.

The computation device 901 is a CPU (Central Processing Unit) which executes the program.

The external storage device 902 is, for example, a ROM (Read Only Memory), a flash memory, or a hard disk unit.

The main storage device 903 is a RAM (Random Access Memory).

The communication device 904 is, for example, a communication board, and is connected to a LAN (Local Area Network) or the like. The communication device 904 is not necessarily connected to a LAN but may be connected to a WAN (Wide Area Network) such as an IP-VPN (Internet Protocol Virtual Private Network), a wide-area LAN, or an ATM (Asynchronous Transfer Mode) network; or the Internet. The LAN, the WAN, and the Internet are examples of a network.

The input/output device 905 is, for example, a mouse, a keyboard, or a display device. A touch panel, a touch pad, a track ball, a pen tablet, or any other pointing device may be used in place of the mouse. The display device may be an LCD (Liquid Crystal Display), a CRT (Cathode Ray Tube), or any other displaying device.

The program is usually stored in the external storage device 902. The program is loaded to the main storage device 903, and sequentially read and executed by the computation device 901.

The program is a program that implements the functions each described as “unit” illustrated in the block configuration diagram.

A program product (computer program product) is constituted of a storage medium, a storage device, or the like which records the program that implements the functions each described as “unit” illustrated in the block configuration diagram. A program product, regardless of how it may look, refers to a substance loaded with a computer-readable program.

Furthermore, an operating system (OS) is also stored in the external storage device 902. At least part of the OS is loaded to the main storage device 903. The computation device 901, while executing the OS, executes the program which implements the functions of each “unit” illustrated in the block configuration diagram.

Application programs are also stored in the external storage device 902. The application programs are loaded to the main storage device 903 and sequentially executed by the computation device 901.

Information such as “table” is also stored in the external storage device 902.

Information, data, signal values, and variable values indicating the results of processes such as “decide”, “check”, “extract”, “detect”, “set”, “register”, “select”, “generate”, “take as input”, and “output” are stored in the main storage device 903.

The data received by the authentication setting device 200 and the authentication execution device 300 are stored in the main storage device 903.

Encryption keys and decryption keys, random number values, and parameters may be stored in the main storage device 903.

The configuration of FIG. 2 is merely an example of the hardware configuration of the authentication setting device 200 and authentication execution device 300. The hardware configuration of the authentication setting device 200 and authentication execution device 300 is not limited to the configuration illustrated in FIG. 2, but may be another configuration.

FIG. 3 is a diagram illustrating an example of the control system 500 and configuration information 510 according to this embodiment.

As illustrated in FIG. 3, the control system 500 includes instruments such as a power supply, an input instrument, and an output instrument. The control system 500 also includes a PLC which controls these instruments. The instruments such as the power supply, input instrument, and output instrument are connected to the PLC.

Since the authentication setting device 200 is connected to the PLC via the communication path 400, the authentication setting device 200 is connected to the authentication execution device 300 incorporated in the PLC.

The collection unit 308 of the authentication execution device 300 collects the connection numbers in sequence, the model numbers, and pieces of inherent information of the instruments (the power supply, input instrument, and output instrument in the example illustrated in FIG. 3) connected to the PLC from the instruments, and generates the configuration information 510.

The connection numbers in sequence refer to the connection numbers of the instruments constituting the control system 500. In the example illustrated in FIG. 3, the power supply is connected first, the PLC is connected second, the input instrument is connected third, and the output instrument is connected fourth. The inherent information is a manufacture number (serial number) or the like that allows identification of the individual instrument. The inherent information is generally managed by a security microcomputer or the like securely and cannot be tampered. When the authentication execution device 300 receives the setting request for the instrument authentication information, the configuration information 510 collected by the collection unit 308 is transmitted to the authentication setting device 200 via the device communication unit 307 and the communication unit 205 and is stored in the information storage unit 204. The configuration information 510 is displayed by the information display unit 202 in response to the user's display request so that the user can view the configuration information 510.

While instruments such as the power supply, the input instrument, and the output instrument are listed as practical examples of the instruments, the instrument may be other instruments. The types of instruments connected to the PLC are arbitrary. While the connection numbers in sequence, model numbers, and pieces of inherent information are listed as practical examples of the configuration information 510, the information to be collected as the configuration information 510 may be any other information. The information to be collected as the configuration information 510 is arbitrary.

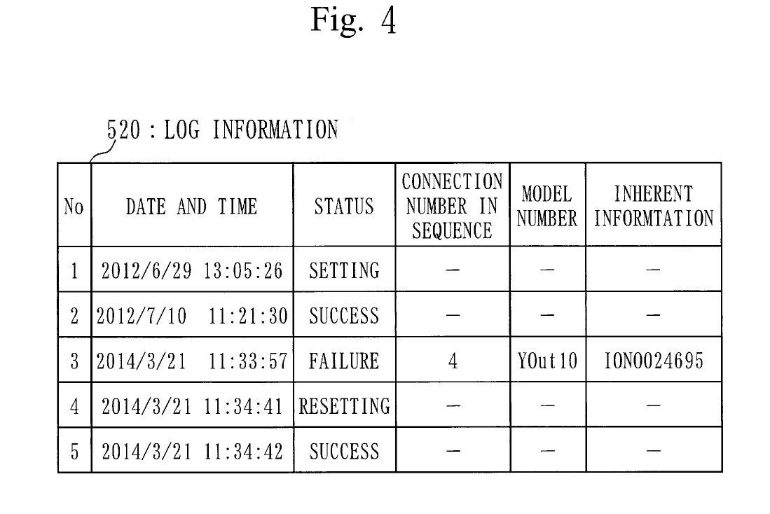

FIG. 4 is a diagram illustrating an example of log information 520 being an instrument authentication result of the instrument authentication process which is executed by the authentication management device 100 according to this embodiment.

In the authentication management device 100, the instrument authentication result of the instrument authentication process executed in the initial process of the time the power supply of the PLC is turned on is stored in the PLC as the log information 520.

As illustrated in FIG. 4, for example, the log information 520 records the date and time; the status; and the connection numbers in sequence, the model numbers, and the inherent information of when the instrument authentication has failed.

In the log information 520, the date and time of when the instrument authentication information is set, the date and time of when the instrument authentication is practiced, and the date and time of when resetting of the instrument authentication information is practiced are recorded in the time field.

Setting of the instrument authentication information, resetting of the instrument authentication information, and the result of instrument authentication are recorded in the status field.

When the instrument authentication fails, the connection number in sequence, the model number, and the inherent information of an instrument whose configuration does not agree with the instrument authentication information are recorded. For setting and resetting of the instrument authentication information, and for successful instrument authentication, a hyphen “-” is set in each of fields of the connection number in sequence, the model number, and the inherent information.

When the authentication unit 309 decides that the authentication-use instrument attribute information does not agree with the instrument authentication information, the log information 520 is an example of disagreed information, being information that does not agree with the instrument authentication information, out of the authentication-use instrument attribute information.

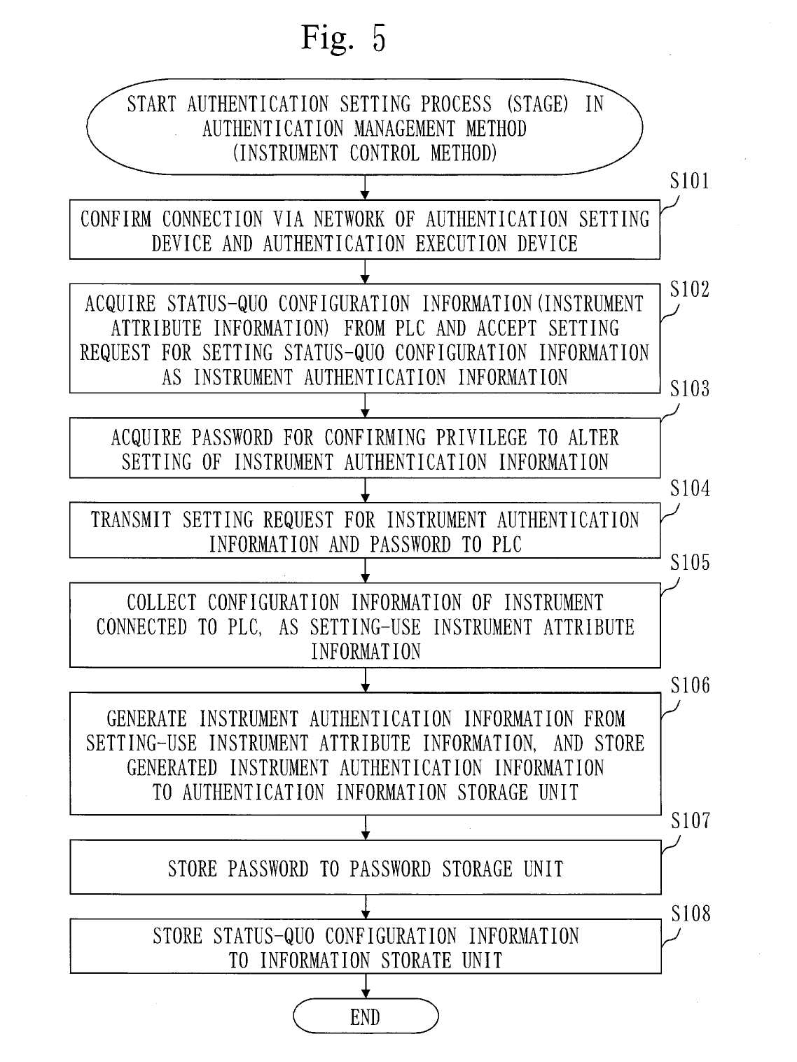

FIG. 5 is a flowchart illustrating an operation of an authentication setting process (stage) in an authentication management method (instrument control method) according to this embodiment.

The operation of the authentication setting process (stage) in the authentication management method according to this embodiment will be described with reference to FIG. 5.

The authentication setting process is a process of when setting of the instrument authentication information is to be executed.

The process of S101 will be described.

In S101, the input reception unit 201 accepts an input of a display request for the configuration information 510 of the control system 500, from the user.

Upon acquisition of the display request for the configuration information 510 from the input reception unit 201, the information display unit 202 outputs a connection confirmation request for checking the connection state between the authentication setting device 200 and the PLC, to the authentication setting unit 203. The authentication setting unit 203 transmits the connection confirmation request to the authentication execution device 300 via the communication unit 205. The authentication setting unit 203 receives a response to the connection confirmation request and checks whether or not the authentication setting device 200 and the PLC are connected to each other, based on the received response.

The process of S102 will be described.

When it is confirmed that the authentication setting unit 203 is connected to the authentication execution device 300, the authentication setting unit 203 transmits a configuration information acquisition request requesting acquisition of the current configuration information 510 (instrument attribute information) to the authentication execution device 300.

The device communication unit 307 of the authentication execution device 300 receives the configuration information acquisition request transmitted from the authentication setting device 200. Upon reception of the configuration information acquisition request, the device communication unit 307 instructs the collection unit 308 to collect the configuration information 510 of the instruments connected to the PLC.

The collection unit 308 collects the configuration information 510 of the instruments connected to the PLC and transmits the collected configuration information 510 to the authentication setting device 200 via the device communication unit 307.

The communication unit 205 of the authentication setting device 200 receives the configuration information 510 from the authentication execution device 300. The communication unit 205 outputs the received configuration information 510 to the information display unit 202 via the authentication setting unit 203. The information display unit 202 displays the acquired configuration information 510.

The user confirms the configuration information 510 of the control system 500 displayed by the information display unit 202.

The input reception unit 201 receives from the user an instruction for setting the instrument authentication information corresponding to the configuration of the instruments indicated by the displayed configuration information 510. More specifically, upon confirming that the status-quo configuration information 510 is the formal configuration information, the user enters to the input reception unit 201 a setting request requesting to set the configuration information 510 as the instrument authentication information used for authentication.

The process of S103 will be described.

Upon acceptance of the setting instruction for instrument authentication, the input reception unit 201 checks with a processing device whether or not this is the first time to set the instrument authentication information for the PLC.

If the input reception unit 201 decides that this is the first time to set the instrument authentication information for the PLC, the input reception unit 201 displays the password setting screen by means of the setting screen display unit 206, and requests the user to enter a password for checking the privilege to alter the setting of the instrument authentication information. This password is an authentication-use password that limits permission to alter setting of the instrument authentication information, to the user who was successful in password authentication.

The setting screen display unit 206 acquires the password the user entered on the password setting screen. The setting screen display unit 206 outputs the acquired password to the authentication setting unit 203.

The process of S104 will be described.

When acquisition of the password by the setting screen display unit 206 is completed, the authentication setting unit 203 transmits a setting request being an instruction to set the instrument authentication information, to the authentication execution device 300 (PLC). At this time, the authentication setting unit 203 also transmits the password the user entered in the process of S103, to the authentication execution device 300.

The device communication unit 307 receives the setting request and password from the authentication setting device 200. The device communication unit 307 outputs the received setting request and the password to the authentication unit 309.

The process of S105 will be described.

Upon acquisition of the setting request and the password from the device communication unit 307, the authentication unit 309 outputs a collection request requesting collection of the status-quo configuration information 510 to the collection unit 308. Upon acquisition of the collection request, the collection unit 308 collects the configuration information 510 of the time the collection request is acquired, from the instruments connected to the PLC. The collection unit 308 outputs the collected configuration information 510 to the authentication unit 309 as setting-use instrument attribute information 511.

The collection unit 308 may temporarily store in the memory the configuration information 510 collected in the process of S102, and output the configuration information 510 to the authentication unit 309 as the setting-use instrument attribute information 511.

The process of S106 will be described.

The authentication unit 309 acquires the setting-use instrument attribute information 511 from the collection unit 308. The authentication unit 309 outputs the acquired setting-use instrument attribute information 511 to the authentication information generation unit 312 to instruct generation of instrument authentication information 512 by conversion of the setting-use instrument attribute information 511.

The authentication information generation unit 312 generates the instrument authentication information 512 based on the setting-use instrument attribute information 511 received from the authentication unit 309. The authentication information generation unit 312, instead of holding the setting-use instrument attribute information 511 (configuration information 510) in a state as illustrated in FIG. 3, generates, for example, information by converting the setting-use instrument attribute information 511 into a hash value based on the connection numbers in sequence and the inherent information, and stores the generated information to the authentication information storage unit 313 as the instrument authentication information 512.

The authentication result storage unit 316 stores, in the storage device, the log information 520 indicating that the setting-use instrument attribute information 511 has been stored in the authentication information storage unit 313 as the instrument authentication information 512. The authentication result storage unit 316 stores setting completion of the instrument authentication information, to the authentication result storage unit 316, as in the 1st row (No 1) of the log information 520 illustrated in FIG. 4.

The authentication information generation unit 312 may store the setting-use instrument attribute information 511 to the authentication information storage unit 313 as the instrument authentication information 512 unchanged, without converting the setting-use instrument attribute information 511.

The process of S107 will be described.

The authentication information generation unit 312 notifies the authentication unit 309 that the instrument authentication information 512 has been completely stored in the authentication information storage unit 313. Upon acceptance of this notification, the authentication unit 309 asks the password authentication unit 310 to register the password accepted from the authentication setting device 200, together with the setting request.

The password authentication unit 310 stores the accepted password to the password storage unit 311. At this time, instead of storing the password in the form of an original plaintext, the password authentication unit 310 converts the password into, for example, a hash value, and stores the password in the form of a hash value. The password authentication unit 310 stores the password being converted into the hash value, to the password storage unit 311.

The password authentication unit 310 notifies the authentication unit 309 of the completion of storing the password.

The authentication unit 309 transmits a notice notifying the completion of setting the instrument authentication information, to the authentication setting device 200 via the device communication unit 307.

The process of S108 will be described.

Upon reception of the notice notifying the completion of setting the instrument authentication information, the authentication setting unit 203 of the authentication setting device 200 stores the configuration information 510 acquired in the process of S102 to the information storage unit 204.

So far the authentication setting process of the authentication management device 100 has been described.

The authentication setting process of the authentication management device 100 described with reference to FIG. 5 is a task the device manufacturer being the user practices before delivering the control system 500 being the device, to the end user. According to the authentication setting process of the authentication management device 100, the user can visually check the configuration information of the control system 500. This rests on the premise that the communication path 400 between the authentication setting device 200 and the authentication execution device 300 is secure.

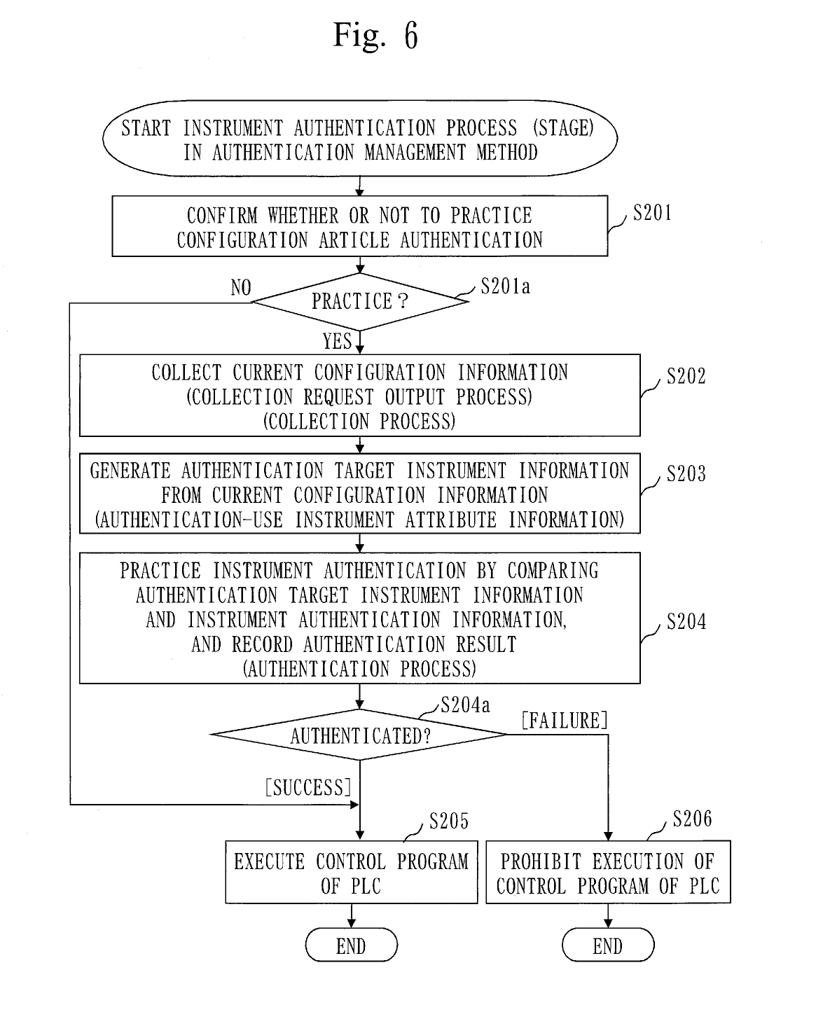

FIG. 6 is a flowchart illustrating an operation of the instrument authentication process (stage) in an authentication management method according to this embodiment.

An operation of the instrument authentication process according to this embodiment will be described with reference to FIG. 6.

The instrument authentication process is a process executed in the initial process which is executed at the time the power supply of the PLC is turned on.

The process of S201 will be described.

The authentication unit 309 executes the instrument authentication process, in the initial process of the firmware which is executed at the time the power supply of the PLC is turned on.

The authentication unit 309 checks whether or not the instrument authentication information 512 is stored in the authentication information storage unit 313, and decides whether the instrument authentication process is necessary.

If the instrument authentication information 512 is stored, the authentication unit 309 decides to conduct the instrument authentication process (YES in S201a). The authentication unit 309 acquires the instrument authentication information 512 from the authentication information storage unit 313. Also, the authentication unit 309 requests the collection unit 308 to collect the configuration information 510 of the current control system 500.

If the instrument authentication information 512 is not stored, the authentication unit 309 decides not to practice the instrument authentication process (NO in S201a), and proceeds to S205.

The process of S202 will be described.

When the authentication unit 309 decides to practice the instrument authentication process, it outputs the authentication request indicating a request for authentication of the instruments to the collection unit 308.

The collection unit 308 acquires the authentication request from the authentication unit 309, collects the configuration information 510 (model numbers, pieces of inherent information, and connection numbers in sequence) of the instruments connected to the PCL, as the authentication-use instrument attribute information 513, and outputs the authentication-use instrument attribute information 513 to the authentication unit 309. More specifically, if the collection unit 308 acquires an authentication request after the instrument authentication information 512 is set, the collection unit 308 collects the instrument attribute information of the time the authentication request is acquired, as authentication-use instrument attribute information 513 to be used for instrument authentication.

The process of S203 will be described.

The authentication unit 309 acquires the authentication-use instrument attribute information 513 (configuration information 510) collected by the collection unit 308.

The authentication unit 309 outputs the authentication-use instrument attribute information 513 acquired from the collection unit 308, to the authentication information generation unit 312 to ask for conversion of the authentication-use instrument attribute information 513.

The authentication information generation unit 312 converts the authentication-use instrument attribute information 513 by the same algorithm as that of the process of S106, thus generating authentication target instrument information 514. The authentication information generation unit 312 outputs the generated authentication target instrument information 514 to the authentication unit 309.

The process of S204 will be described.

The authentication unit 309 compares, by the processing device, the instrument authentication information 512 stored in the authentication information storage unit 313 with the authentication target instrument information 514 generated by the authentication information generation unit 312, and authenticates the instruments of the control system 500.

The authentication unit 309 checks by the processing device whether or not the authentication target instrument information 514 agrees with the instrument authentication information 512. If they do not agree, the authentication unit 309 decides that instrument authentication fails. If the authentication target instrument information 514 agrees with the instrument authentication information 512, the authentication unit 309 decides that instrument authentication is successful.

The authentication unit 309 stores the authentication result to the authentication result storage unit 316 as the log information 520.

Failure of the instrument authentication signifies that the configuration information 510 has been altered after the instrument authentication information 512 is set. In the instrument authentication process according to this embodiment, the instruments are checked individually as to whether their configuration has been altered.

If the authentication unit 309 decides that instrument authentication is successful (success in S204a), it proceeds to S205.

If the authentication unit 309 decides that instrument authentication fails (failure in S204a), it proceeds to S206.

The process of S205 will be described.

If instrument authentication practiced by the authentication unit 309 is successful, namely, if the authentication target instrument information 514 agrees with the instrument authentication information 512, the authentication unit 309 notifies the control management unit 315 of the result of instrument authentication. Upon reception of the authentication result success notice, the control management unit 315 reads the control program stored in the control program storage unit 314 and serving to control the control target instruments such as the sensor, and executes the control program.

The process of S206 will be described.

If instrument authentication practiced by the authentication unit 309 fails (the authentication target instrument information 514 does not agree with the instrument authentication information 512), the authentication unit 309 notifies the control management unit 315 of the result of instrument authentication being a failure. Upon reception of the authentication result failure notice from the authentication unit 309, the control management unit 315 prohibits execution of the control program.

So far the instrument authentication process by the authentication management device 100 has been described.

Upon reception of a resetting request requesting resetting of the instrument authentication information from the authentication setting device 200, the PCL which is prohibited to execute the control program updates the instrument authentication information 512. The PLC is unable to execute the control program until instrument authentication is successful.

This embodiment indicates an example in which execution of the control program is prohibited if instrument authentication fails. However, for example, when the instrument authentication is to be set by the user (device manufacturer), the user (device manufacturer) may be able to set whether the control program can be executed or not, and execution control of the control program may be practiced according to this setting.

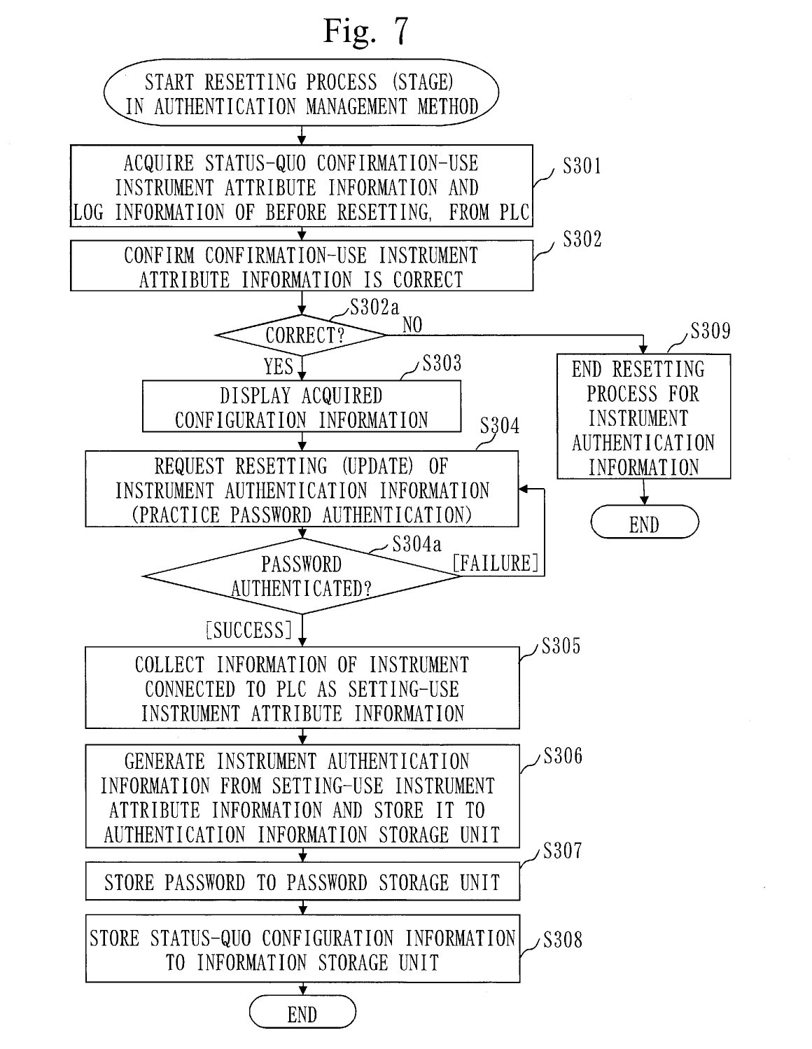

FIG. 7 is a flowchart illustrating an operation of a resetting process (stage) for instrument authentication information in an authentication management method according to this embodiment.

FIG. 7 illustrates a process flowchart of how resetting of the instrument authentication information is practiced. The operation of this resetting will be described through an example in which it is necessary to reset the instrument authentication information from a remote location, mostly in cases where the device manufacturer (user) and the end user are far away from each other. The cases where the device manufacturer (user) and the end user are far away from each other are, for example, cases where the end user resides overseas.

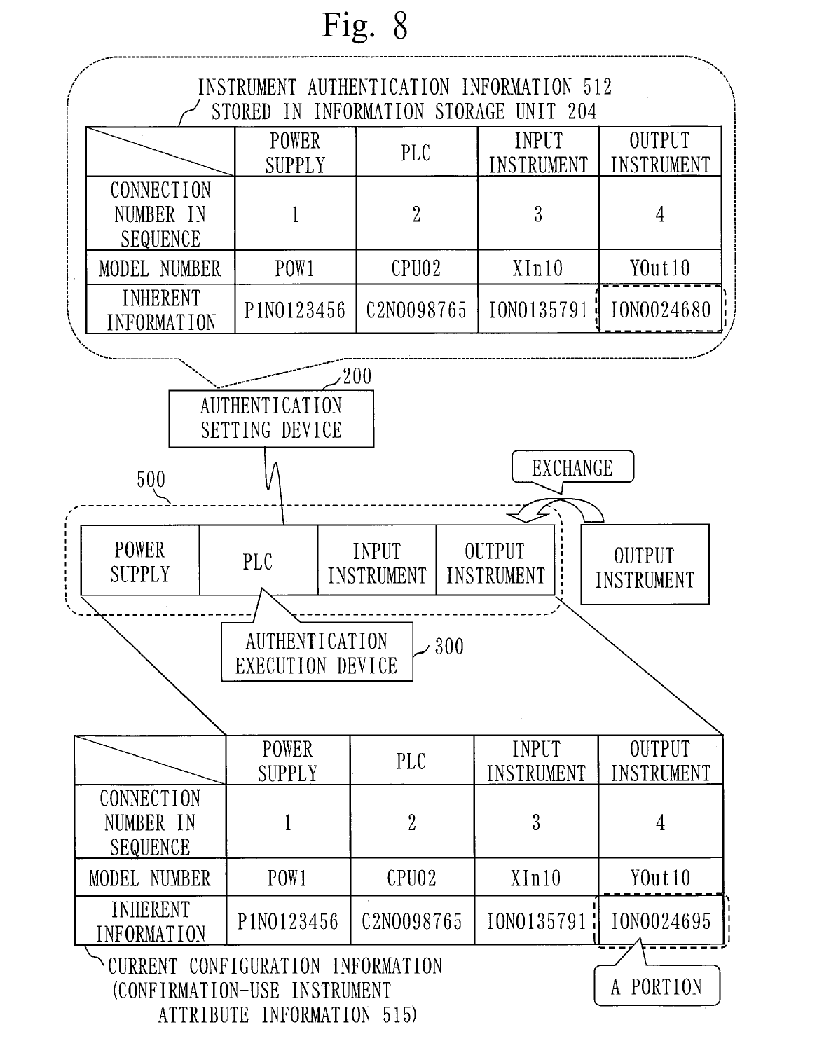

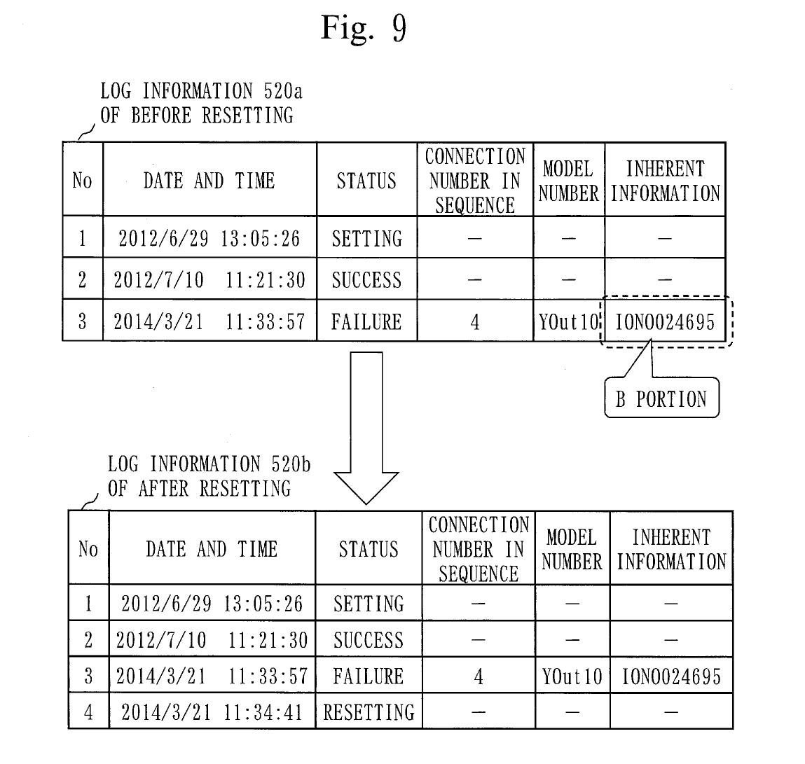

FIG. 8 is a diagram describing a case where an output instrument in the control system 500 (device) is exchanged (replaced) by an output instrument having the same model number but different inherent information. FIG. 9 is a diagram illustrating the log information 520 in the authentication management device 100 according to this embodiment, illustrating an example of log information 520a of the time before resetting of instrument authentication information is practiced, and an example of log information 520b of the time after resetting of instrument authentication information is practiced.

An operation of the resetting process according to this embodiment will be described with reference to FIGS. 7 to 9.

The process of S301 will be described.

The input reception unit 201 accepts an input of a confirmation request requesting confirmation of the configuration information 510 of the control system 500, from the user.

Upon acquisition of the confirmation request from the input reception unit 201, the information display unit 202 outputs a connection confirmation request for the connection state between the authentication setting device 200 and the PLC, to the authentication setting unit 203.

The authentication setting unit 203 checks whether or not the authentication setting device 200 is connected to the authentication execution device 300 (PLC) via the communication unit 205.

If the authentication setting device 200 and the authentication execution device 300 are not connected to each other, the authentication setting unit 203 may acquire the instrument authentication information 512 (configuration information 510) stored in the information storage unit 204 and output it to the information display unit 202. In this case, the information display unit 202 displays the accepted instrument authentication information 512 (configuration information 510). As the authentication setting device 200 and the authentication execution device 300 are not connected to each other, however, the resetting process for the instrument authentication information cannot be conducted.

The following description rests on the premise that the authentication setting device 200 and the authentication execution device 300 are connected to each other.

When the authentication setting device 200 is connected to the PLC, the authentication setting unit 203 transmits a confirmation request requesting confirmation of the current configuration information 510 to the authentication execution device 300 (PLC).

The device communication unit 307 of the authentication execution device 300 receives the confirmation request transmitted from the authentication setting device 200. Upon reception of the confirmation request, the device communication unit 307 instructs the collection unit 308 to collect the configuration information 510 of the instruments connected to the PLC.

Upon acquisition of the confirmation request, the collection unit 308 collects the configuration information 510 of the instruments connected to the PLC, thus acquiring the configuration information 510. More specifically, upon reception of the confirmation request from the authentication setting unit 203, the collection unit 308 collects the configuration information 510 (instrument attribute information) of the time the confirmation request is received, as confirmation-use instrument attribute information 515. The collection unit 308 also acquires the log information 520 stored by the authentication result storage unit 316.

The collection unit 308 transmits the collected confirmation-use instrument attribute information 515 of the control system 500 and the acquired log information 520 to the authentication setting device 200 via the device communication unit 307. More specifically, the device communication unit 307 transmits the confirmation-use instrument attribute information 515 collected by the collection unit 308 and the log information 520 (disagreed information) to the authentication setting device 200, as a confirmation response to the confirmation request.

The authentication setting device 200 receives the confirmation-use instrument attribute information 515 and the log information 520 from the authentication execution device 300.

The process of S302 will be described.

The authentication setting unit 203 checks whether or not the confirmation-use instrument attribute information 515 received from the authentication execution device 300 is correct.

The authentication setting unit 203 compares the confirmation-use instrument attribute information 515 (configuration information 510) received from the authentication execution device 300 with the instrument authentication information 512 stored in the information storage unit 204.

As the result of the comparison, if the confirmation-use instrument attribute information 515 and the instrument authentication information 512 agree, the resetting process is not necessary. This is because if agreement is found between the confirmation-use instrument attribute information 515 and the instrument authentication information 512, it indicates that the configuration information of the status-quo control system is regular information.

If the authentication setting device 200 accepts an input of the confirmation request, it signifies that because the control of the instrument by the PLC has been stopped, the user confirms the configuration information 510 of the instruments and intends to reset the instrument authentication information 512 where necessary. Hence, the following description is based on the assumption that the confirmation-use instrument attribute information 515 and the instrument authentication information 512 do not agree with each other.

Cases where the confirmation-use instrument attribute information 515 and the instrument authentication information 512 do not agree with each other may be, for example, a case where due to trouble of an output instrument, the output instrument has been exchanged for an output instrument having the same model number but different inherent information. In such a case, the authentication setting unit 203 compares the confirmation-use instrument attribute information 515 with the instrument authentication information 512, and decides that corresponding pieces of inherent information of the output instruments are different, and that the confirmation-use instrument attribute information 515 and the instrument authentication information 512 do not agree with each other.

The authentication setting unit 203 analyzes the log information 520 accepted from the authentication execution device 300 together with the confirmation-use instrument attribute information 515, and checks whether or not the difference between the confirmation-use instrument attribute information 515 and the instrument authentication information 512 is consistent with the log information 520, thereby checking whether or not the confirmation-use instrument attribute information 515 is correct.

The configuration information 510 in the upper portion of FIG. 8 is an example of the instrument authentication information 512 stored in the information storage unit 204 of the authentication setting device 200. The configuration information 510 in the lower portion of FIG. 8 is an example of the current confirmation-use instrument attribute information 515. Being current refers to a vicinity of the time point the authentication execution device 300 has received the confirmation request from the user. As illustrated in the middle portion of FIG. 8, if the output instrument has been exchanged, the inherent information of the output instrument differs between the confirmation-use instrument attribute information 515 and the instrument authentication information 512, as illustrated in a dashed-line frame.

Regarding the result of the instrument authentication process executed at the time the power supply of the PLC is turned on after the output instrument is exchanged, authentication failure is recorded as the status, and the inherent information of the output instrument which disagrees with the instrument authentication information 512 is set as the inherent information, as in the 3rd row (No 3) of the log information 520a of the time before the resetting process illustrated in FIG. 9.

The authentication setting unit 203 compares a portion (B portion in FIG. 9), indicating authentication failure, in the log information 520a of the time before the resetting process, with a portion (A portion in FIG. 8) in the confirmation-use instrument attribute information 515, that does not agree with the instrument authentication information 512. If the A portion and the B portion are identical, the authentication setting unit 203 decides that the confirmation-use instrument attribute information 515 accepted from the authentication execution device 300 is correct.

More specifically, upon reception of the confirmation response from the authentication execution device 300, the authentication setting unit 203, by the processing device, checks whether or not the confirmation-use instrument attribute information 515 included in the confirmation response agrees with the instrument authentication information 512. If it is decided that agreement is not found, the authentication setting unit 203 checks whether or not, of the confirmation-use instrument attribute information 515, information that does not agree with the instrument authentication information 512, and the disagreed information (inherent information of the time authentication fails) of the log information 520a agree. If it is decided that agreement is found, the authentication setting unit 203 decides that the confirmation-use instrument attribute information 515 is correct information.

If the confirmation-use instrument attribute information 515 is correct (YES in S302a), the authentication setting unit 203 proceeds to S303.

If the confirmation-use instrument attribute information 515 is not correct (NO in S302a), the authentication setting unit 203 proceeds to S309.

When agreement is found between the information, of the confirmation-use instrument attribute information 515, that does not agree with the instrument authentication information 512, and the disagreed information of the log information 520, it is regarded that there is consistency between the confirmation-use instrument attribute information 515 and the log information 520a.

If there is no consistency between the confirmation-use instrument attribute information 515 and the log information 520a, it signifies that the configuration information 510 (confirmation-use instrument attribute information 515) of the actual control system 500 may include an error, or that data may have been tampered in the communication path 400 between the authentication setting device 200 and the authentication execution device 300. Accordingly, in S309, the authentication setting unit 203 stops the resetting process for the instrument authentication information.

A case will now be described where there is consistency between the disagreed portion of the confirmation-use instrument attribute information 515 and the disagreed portion of the log information 520a.

The process of S303 will be described.

If it is decided that the confirmation-use instrument attribute information 515 acquired from the authentication execution device 300 is correct, the authentication setting unit 203 outputs the confirmation-use instrument attribute information 515 to the information display unit 202. The information display unit 202 displays the confirmation-use instrument attribute information 515 acquired from the authentication setting unit 203.

The process of S304 will be described.

The input reception unit 201 accepts from the user a resetting instruction being an instruction to set the confirmation-use instrument attribute information 515 as the instrument authentication information, and outputs the resetting instruction to the authentication setting unit 203. The resetting instruction is an example of a setting request for setting the confirmation-use instrument attribute information 515 as the instrument authentication information.

The authentication setting unit 203 acquires the resetting instruction from the input reception unit 201. The authentication setting unit 203 asks the user to conduct password authentication in order to confirm that the user has the privilege to alter setting of the instrument authentication. The authentication setting unit 203 notifies the setting screen display unit 206 of a password authentication request. The setting screen display unit 206 displays a log-in screen and prompts the user to enter the password. When the input reception unit 201 accepts the password entered by the user, the setting screen display unit 206 outputs the entered password to the authentication setting unit 203. The authentication setting unit 203 transmits a password authentication request requesting authentication of the password acquired from the setting screen display unit 206, to the authentication execution device 300 via the communication unit 205.

The authentication unit 309 of the authentication execution device 300 receives the password authentication request from the authentication setting device 200 via the device communication unit 307.

Upon acquisition of the password authentication request, the authentication unit 309 instructs the password authentication unit 310 to generate a random number (challenge). The password authentication unit 310 generates a random number and outputs the generated random number to the authentication unit 309. The password authentication unit 310 also stores the generated random number temporarily into the password authentication unit 310.

The authentication unit 309 transmits the random number acquired from the password authentication unit 310 to the authentication setting device 200 via the device communication unit 307.

The authentication setting unit 203 of the authentication setting device 200 generates an authentication-use response, using the received random number (challenge) and the password which is acquired from the user by the setting screen display unit 206. The authentication setting unit 203 generates the authentication-use response by, for example, converting the password into a hash value in accordance with a hash function using the random number as a key. The authentication setting unit 203 transmits the generated authentication-use response and the resetting request for the instrument authentication information, to the authentication execution device 300 via the communication unit 205.

In the instrument authentication setting process, when the password is to be stored in the password storage unit 311, if the password has been converted into a hash value or the like, the authentication setting unit 203 generates the authentication-use response by converting the password entered by the user, in accordance with the same method as the method of converting the password into the hash value.

The authentication unit 309 of the authentication execution device 300 transfers the authentication-use response received from the authentication setting device 200 to the password authentication unit 310, and instructs the password authentication unit 310 to conduct password authentication. The password authentication unit 310 generates a confirmation-use response from the temporarily stored random number and the password stored in the password storage unit 311, in accordance with the same method as that employed when the authentication-use response is generated in the authentication setting unit 203.

The password authentication unit 310 practices password authentication by comparing the generated confirmation-use response with the authentication-use response received from the authentication setting device 200, and outputs the authentication result of password authentication to the authentication unit 309.

If the authentication of password authentication results in failure (failure in S304a), the authentication unit 309 returns to the process of S304. The authentication management device 100 asks the user to enter the password again, and practices password authentication again. When the number of times password authentication fails consecutively reaches a predetermined number of times, it is decided that there is a possibility of a fraudulent access undergoing, and the password authentication process is ended. The authentication execution device 300 will not accept a resetting request for the instrument authentication information from the authentication setting device 200 for a predetermined period of time or more.

If the authentication of password authentication results in success (success in S304a), the authentication unit 309 executes the process of S305 to S308. Since the process of S305 to S308 is the same process as the process of S105 to S108 described with reference to FIG. 5, its detailed description thereof will be omitted, and only its outline will be described.

In S305, the authentication execution device 300 collects information of the instruments connected to the PLC, thus acquiring the configuration information 510. In S306, the authentication execution device 300 generates the instrument authentication information 512 from the acquired configuration information 510 and stores the instrument authentication information 512 to the authentication information storage unit 313. In S307, the authentication execution device 300 stores the authentication-use password (or confirmation-use password) to the password storage unit 311. In S308, the authentication execution device 300 transmits the collected configuration information 510 to the authentication setting device 200. The authentication setting device 200 stores the received configuration information 510 to the information storage unit 204.

So far the resetting process for the instrument authentication information in the authentication management device 100 has been described.

As described above, with the authentication management device 100 according to this embodiment, it is possible to perform: setting which is necessary for conducting authentication using the model numbers, pieces of inherent information, and the connection numbers in sequence of the instruments, with respect to the configuration information of the control system 500 (device); execution of the instrument authentication process; and execution control of the control program in accordance with the authentication result. Therefore, with the authentication management device 100 according to this embodiment, the repair cost incurred due to trouble occurring in the control system (device), because the end user has arbitrarily altered the configuration of the control system which the user (device manufacturer) had delivered to the end user, can be reduced.

The user (device manufacturer) can practice resetting of the instrument authentication information for the control system which the user has delivered to the end user, while checking the configuration information of the PLC and the pieces of configuration information of the instruments connected to the PLC, even from a remote location.

### Embodiment 2

In this embodiment, matters that are different from Embodiment 1 will mainly be described.

In this embodiment, the constituent units having the same functions as those of the constituent units described in Embodiment 1 will be denoted by the same reference numerals, and a description thereof will sometimes be omitted.

For the authentication management device 100 according to Embodiment 1, all instruments of the control system 500 are dealt with as the target of instrument authentication. In this embodiment, a configuration will now be described which allows the user (device manufacturer) to arbitrarily select an instrument to deal with as the target of instrument authentication. As for an authentication management device 100 according to this embodiment, a function that can authenticate only an instrument selected by the user will be described.

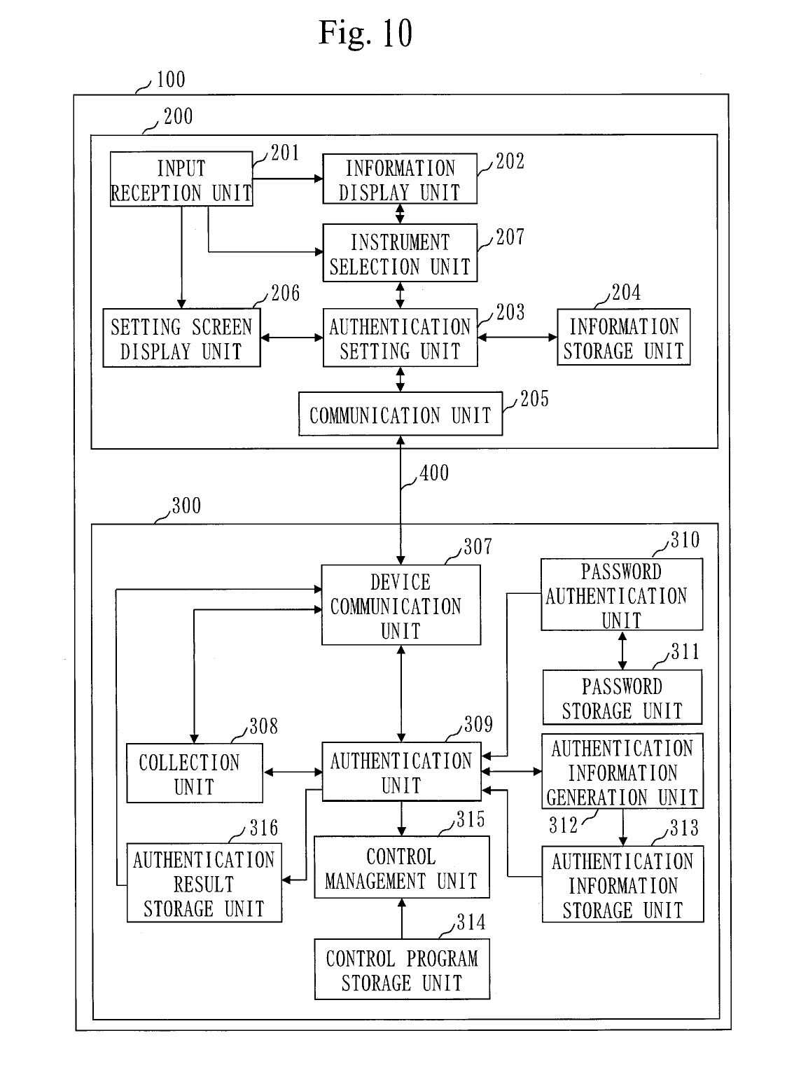

FIG. 10 is a diagram illustrating an example of a block configuration of the authentication management device 100 according to this embodiment.

An authentication setting device 200 according to this embodiment includes an instrument selection unit 207, in addition to the configuration described in Embodiment 1.

The instrument selection unit 207 allows the user to arbitrarily select a target instrument to deal with as the target of instrument authentication, from the instrument configuration displayed by an information display unit 202, using an input reception unit 201.

Note that when the user selects an instrument to deal with as the authentication target, the PLC should always be selected.

The operation will now be described.

With the authentication management device 100 illustrated in FIG. 10, the user can arbitrarily select the target instrument of instrument authentication, on the authentication setting device 200 (PC). Thus, out of the constituent instruments of a control system 500, only a configuration selected as the authentication target by the user can be confirmed as to whether they have not been altered.

In S102 of FIG. 5, the information display unit 202 displays configuration information 510 acquired from an authentication execution device 300. The user confirms the current configuration information 510 displayed.

At this time, the information display unit 202 displays an instrument select screen where the user can select an instrument from the current configuration information 510. The user selects an instrument to be authenticated, as the selected instrument.

At this time, for example, the information display unit 202 may display an instrument select screen designated by default.

When the user selects an instrument on the instrument select screen, the input reception unit 201 accepts entry of the selected instrument.

The instrument selection unit 207 generates the list of the selected instrument which is accepted by the input reception unit 201, as a selected-instrument list. The instrument selection unit 207 notifies an authentication setting unit 203 of the selected-instrument list.

The authentication setting unit 203 transmits the selected-instrument list accepted and a setting request to the authentication execution device 300 via a communication unit 205.

An authentication unit 309 acquires the current configuration information 510 from a collection unit 308, and outputs the acquired configuration information 510 and the selected-instrument list to an authentication information generation unit 312.

The authentication information generation unit 312 extracts information (for example, model number, inherent information, and connection number in sequence) of only the instrument listed on the selected-instrument list, from the accepted configuration information 510, thus generating setting-use instrument attribute information to be used for authentication of only the selected instrument. The authentication information generation unit 312 converts the generated setting-use instrument attribute information by a hash function or the like, thereby generating instrument authentication information 512a.

The authentication information generation unit 312 stores the generated instrument authentication information 512a and the selected-instrument list to an authentication information storage unit 313 and notifies the authentication unit 309 that generation of the instrument authentication information 512a is completed.

Unlike the instrument authentication information 512 described in Embodiment 1, the instrument authentication information 512a is instrument authentication information for authenticating only the selected instrument which is selected by the user.

Upon reception of the notice from the authentication information generation unit 312, the authentication unit 309 notifies the authentication setting device 200 via a device communication unit 307 that setting of the instrument authentication information 512a is completed. Upon acceptance of the setting completion notice on the instrument authentication information 512a, the authentication setting unit 203 stores the current configuration information 510 and the selected-instrument list to an information storage unit 204.

As described above, the authentication management device according to this embodiment can set only an instrument arbitrarily set by the user, as the target of instrument authentication, with respect to the configuration information of the control system (device). The authentication management device can execute authentication using the model number, inherent information, and the connection number in sequence of the selected instrument, and can control execution of the control program in accordance with the authentication result.

Therefore, with the authentication management device according to this embodiment, an unnecessary instrument authentication process can be removed, so that the processing ability improves and the device resource can be used efficiently, for example.

### Embodiment 3

In this embodiment, matters that are different from Embodiments 1 and 2 will mainly be described.

In this embodiment, constituent units having the same functions as those of the constituent units described in Embodiments 1 and 2 will be denoted by the same reference numerals, and a description thereof will sometimes be omitted.

In Embodiment 1, instrument authentication is practiced on the premise that the configuration information (model number, inherent information, connection number in sequence) of every instrument in the control system 500 is consistent. In this embodiment, a type selection function will be described which allows the user (device manufacturer) to select only an information type to deal with as the target of authentication, out of information types included in the configuration information. This type selection function is a function that can set, out of the information types included in the configuration information, only the model number and connection number in sequence of the instrument to deal with, as the target of instrument authentication.

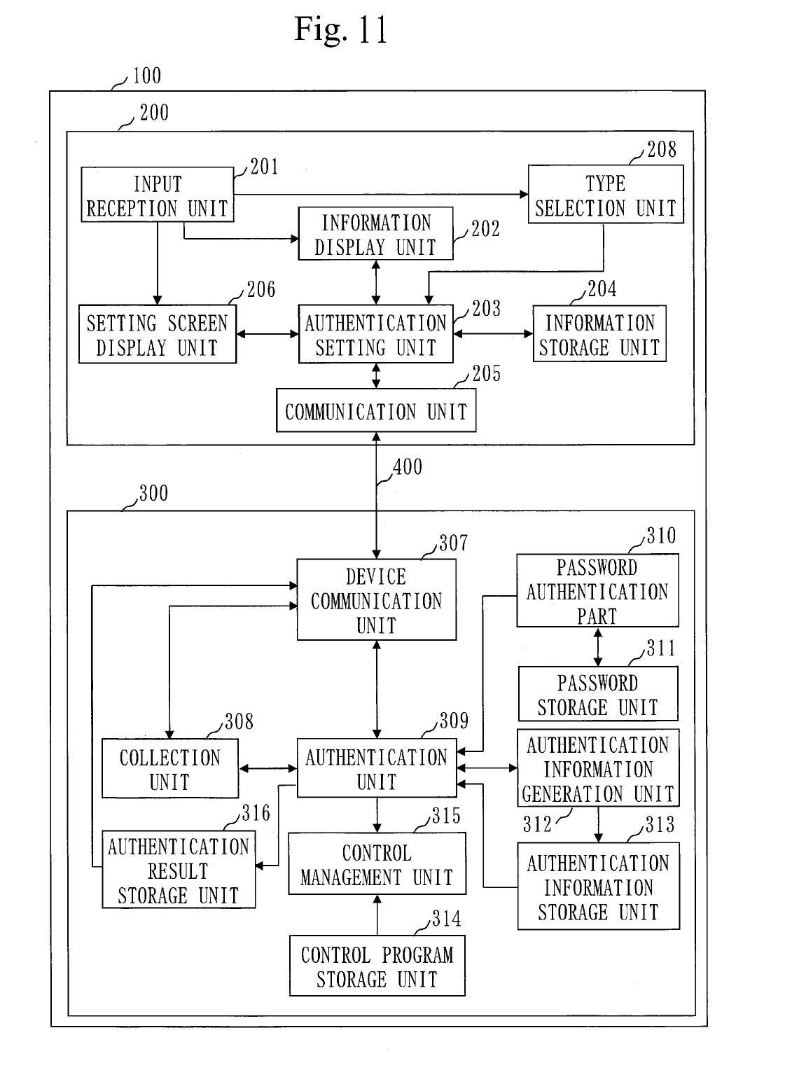

FIG. 11 is a diagram illustrating an example of a block configuration of an authentication management device 100 according to this embodiment.

An authentication setting device 200 according to this embodiment includes a type selection unit 208, in addition to the configuration described in Embodiment 1.

The type selection unit 208 allows the user to arbitrarily select type information to be used for instrument authentication, from the instrument configuration displayed by an information display unit 202, using an input reception unit 201.

Note that when the user selects an information type to be used for instrument authentication, the model number and the connection number in sequence should always be selected. The information type selected by the user is treated as selected information type.

The operation will now be described.

With the authentication management device 100 illustrated in FIG. 11, the user can arbitrarily select the information type to be used for instrument authentication, on the authentication setting device 200 (PC). Thus, of the configuration information of a control system 500, only the selected information type selected by the user can be confirmed as to whether they have not been altered.

In S102 of FIG. 5, the information display unit 202 displays configuration information 510 acquired from an authentication execution device 300. The user confirms the current configuration information 510 displayed.

At this time, the information display unit 202 displays an information type select screen where the user can select an information type to be used for instrument authentication. The user selects an information type to be used for instrument authentication, as the selected information type.

At this time, for example, the information display unit 202 may display an information type select screen where a model number and a connection number in sequence are designated by default.

When the user selects an instrument on the information type select screen, the input reception unit 201 accepts the selected information type entered. For example, the user selects whether or not to include the inherent information of the instrument into the configuration information.

FIG. 11 is a diagram illustrating an authentication management device in which the user (device manufacturer) can set, of the configuration information, only the model number and the connection number in sequence of the instrument, to deal with as the target of instrument authentication, so that instrument authentication is practiced based on this setup information.

The type selection unit 208 generates, as a selected-information-type list, the list of the selected information type which is accepted by the input reception unit 201. The type selection unit 208 notifies an authentication setting unit 203 of the selected-information-type list.

The authentication setting unit 203 transmits the accepted selected-information-type list and a setting request to the authentication execution device 300 via a communication unit 205.

An authentication unit 309 acquires the current configuration information 510 from a collection unit 308, and outputs the acquired current configuration information 510 and the selected-information-type list to an authentication information generation unit 312.

The authentication information generation unit 312 extracts only an information type listed on the selected-information-type list, from the accepted configuration information 510.

For example, if inherent information is selected, the authentication information generation unit 312 extracts the model number, connection number in sequence, and inherent information from among the information types of the configuration information of the instrument.

For example, if inherent information is not selected, the authentication information generation unit 312 extracts only the model number and the connection number in sequence from among the information types of the configuration information of the instrument.

The authentication information generation unit 312 generates configuration information including only the information types listed on the selected-information-type list. Then, treating the configuration information as setting-use instrument attribute information employed for practicing authentication using only the selected information type, the authentication information generation unit 312 converts the setting-use instrument attribute information by a hash function or the like, thereby generating instrument authentication information 512b.

The authentication information generation unit 312 stores the generated instrument authentication information 512b and the selected-information-type list to an authentication information storage unit 313, and notifies the authentication unit 309 that generation of the instrument authentication information 512b is completed.

Unlike the instrument authentication information 512 and 512a described in Embodiments 1 and 2, the instrument authentication information 512b is instrument authentication information employed for authentication using only the selected information type which is selected by the user.

Upon reception of the notice from the authentication information generation unit 312, the authentication unit 309 notifies the authentication setting device 200 via a device communication unit 307 that setting of the instrument authentication information 512b is completed. Upon acceptance of the setting completion notice on the instrument authentication information 512b, the authentication setting unit 203 stores the current configuration information 510 and the selected-information-type list to an information storage unit 204.

As described above, the authentication management device according to this embodiment allows the user (device manufacturer) to set, of the configuration information, only the model number and the connection number in sequence of the instrument, for example, to deal with as the target of instrument authentication. The authentication management device can practice instrument authentication based on this setup information, and control execution of the control program in accordance with the authentication result. Therefore, for example, when an instrument has trouble, the end user can exchange the instrument for an instrument having the same model number arbitrarily, so that the down time of the production line can be shortened.

### Embodiment 4

In this embodiment, matters that are different from Embodiments 1 to 3 will mainly be described.

In this embodiment, constituent units having the same functions as those of the constituent units described in Embodiments 1 to 3 will be denoted by the same reference numerals, and a description thereof will sometimes be omitted.

In Embodiments 1 to 3, for every instrument in the control system, if the configuration information of the instrument is not consistent, instrument authentication fails, and execution control of the control program is practiced. In this embodiment, a function that permits the end user to add a new instrument to the control system will be described.

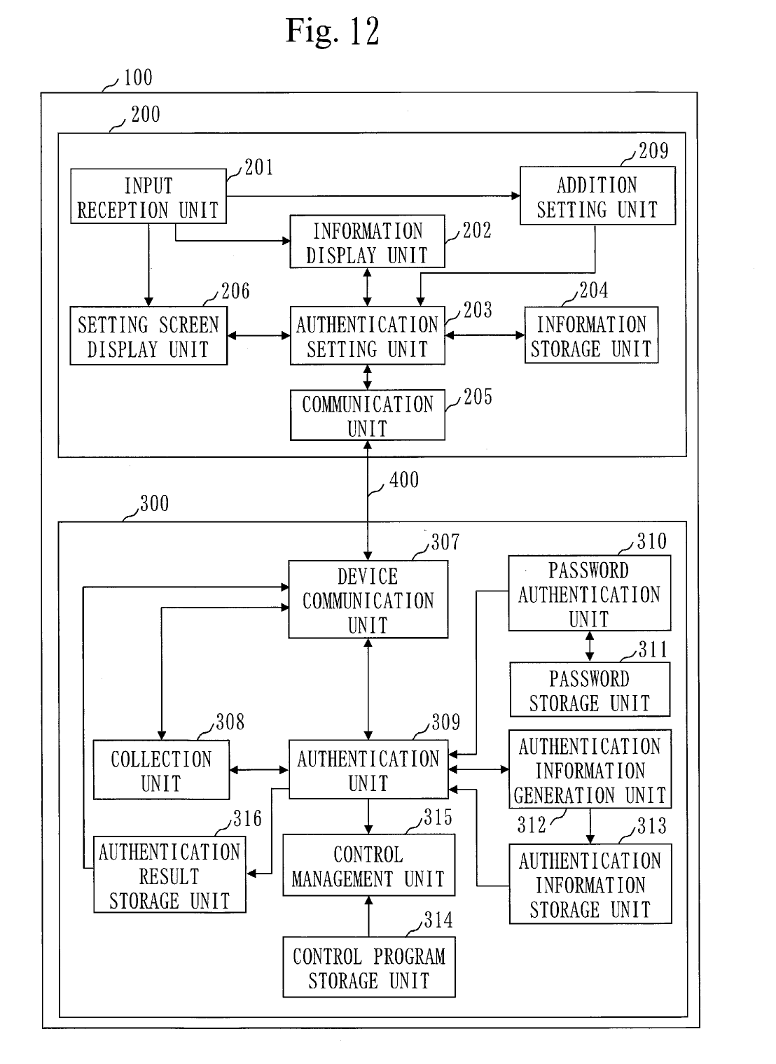

FIG. 12 is a diagram illustrating an example of a block configuration of an authentication management 100 device according to Embodiment 4.

An authentication setting device 200 according to this embodiment includes an addition setting unit 209, in addition to the configuration described in Embodiment 1.

The addition setting unit 209 lets the user arbitrarily select whether or not to limit the target instrument of instrument authentication to the instruments included at the time the device manufacturer had delivered the device, that is, whether or not to permit the end user to add an instrument, with using an input reception unit 201.

For example, sometimes the end user may add an instrument for the purpose of customization of the control system (device). With the authentication management device 100 according to this embodiment, the user (device manufacturer) can select to limit the target instruments of instrument authentication to the instruments included at the time the device manufacturer had delivered the control system (device), while excluding instruments added by the end user from the target of instrument authentication.

The operation will now be described.

With the authentication management device 100 according to this embodiment, when practicing setting of the instrument authentication information, the user (device manufacturer) sets to the addition setting unit 209 whether or not to limit the target instruments of instrument authentication to the instruments included at the time the device manufacturer has delivered the control system (device).

In S102 of FIG. 5, an information display unit 202 displays configuration information 510 acquired from an authentication execution device 300. The user confirms the current configuration information 510 displayed.

At this time, the information display unit 202 displays an addition permit select screen where the user can select whether not to limit the target instruments of instrument authentication to the instruments included at the time of delivery, that is, can select between instrument addition permit and non-permit.

When the user selects either instrument addition permit or non-permit on the addition permit select screen, the input reception unit 201 accepts the entered selection of addition permit or non-permit.

The addition setting unit 209 generates an instrument addition permit flag (an example of addition permit/non-permit information) based on the result of addition permit or non-permit accepted by the input reception unit 201. The addition setting unit 209 notifies an authentication setting unit 203 of the generated instrument addition permit flag.

The authentication setting unit 203 notifies the authentication execution device 300 of the accepted instrument addition permit flag and a setting request via a communication unit 205.

An authentication unit 309 acquires the current configuration information 510 from a collection unit 308, and outputs the acquired current configuration information 510 and the instrument addition permit flag to an authentication information generation unit 312.

The authentication information generation unit 312 generates setting-use instrument attribute information to be employed for setting the instrument authentication information, from the current configuration information 510 accepted. The authentication information generation unit 312 converts the generated setting-use instrument attribute information by, for example, a hash function, thus generating instrument authentication information 512.

The authentication information generation unit 312 stores the generated instrument authentication information 512 and the instrument addition permit flag to an authentication information storage unit 313, and notifies the authentication unit 309 that generation of the instrument authentication information 512 is completed.

Upon acceptance of the notice from the authentication information generation unit 312, the authentication unit 309 notifies the authentication setting device 200, via a device communication unit 307, that setting of instrument authentication is completed.

Upon acceptance of the notice of setting completion of instrument authentication, the authentication setting unit 203 stores the current configuration information 510 and the instrument addition permit flag to an information storage unit 204.

When practicing instrument authentication during the initial process executed at the time the power supply of the PLC is turned on, the authentication unit 309 performs an instrument authentication process using the instrument addition permit flag stored in the authentication information storage unit 313.

In S204 of FIG. 6, the authentication unit 309 compares, by a processing device, the instrument authentication information 512 stored in the authentication information storage unit 313 with authentication target instrument information 514 generated by the authentication information generation unit 312, and authenticates the instruments of a control system 500.

If the authentication unit 309 decides that instrument authentication is successful (success in S204a), it proceeds to S205.

If the authentication unit 309 decides that instrument authentication fails (failure in S204a), it refers to the instrument addition permit flag stored in the authentication information storage unit 313.

If the instrument addition permit flag is ON, the authentication unit 309 decides whether or not the difference between the instrument authentication information 512 and the authentication target instrument information 514 reflects an addition of an instrument.

If the authentication unit 309 decides that the difference reflects addition of an instrument, it concludes that authentication is successful and proceeds to S205.

If the authentication unit 309 decides that the difference does not reflect addition of an instrument, it concludes that authentication fails and proceeds to S206.

If the instrument addition permit flag is OFF, the authentication unit 309 decides that authentication fails and proceeds to S206.

As described above, with the authentication management device according to this embodiment, the user (device manufacturer) can limit the target instruments of instrument authentication to the instruments included at the time the device manufacturer had delivered the control system (device). Thus, the user (device manufacturer) can select to exclude instruments added by the end user for the purpose of customization of the control system (device), from the target of instrument authentication. Thus, the authentication management device can practice authentication for the instruments included at the time the device manufacturer had delivered the control system (device), and can control execution of the control program in accordance with the authentication result.

The block configuration of each of the authentication setting device 200 and of the authentication execution device 300 is not limited to the block configuration described above in Embodiments 1 to 4. The authentication execution device 300 may be implemented by another function block configuration.

For example, in the authentication setting device 200, the input reception unit, the setting screen display unit, and the information display unit may form a single function block as a whole. In the authentication execution device 300, the authentication unit, the collection unit, and the authentication information generation unit may form a single function block configuration as a whole. Various changes may be made to the function block as needed as far as they are not contradictory to the functions described in Embodiments 1 to 4. More specifically, the block configuration described above is arbitrary.

The function block described in Embodiments 1 to 4 may be arranged distributedly in any manner in the authentication management device 100 (instrument control system) as far as it is not contradictory to the functions described in Embodiments 1 to 4.

The authentication management device 100 (instrument control system) may include a file server being a device independent of the authentication setting device 200 or authentication execution device 300.

The embodiments of the present invention have been described. Of the above embodiments, two or more embodiments may be practiced by combination. Alternatively, of the above embodiments, one embodiment may be practiced partially. Alternatively, of the above embodiments, two or more embodiments may be practiced by partial combination.

The above embodiments are essentially preferable exemplifications and are not intended to limit the present invention, the applied product of the present invention, and the scope of usage of the present invention. Various changes may be made to the above embodiments as needed as far as they are not contradictory to the functions described in Embodiments 1 to 4.

### REFERENCE SIGNS LIST

100: authentication management device; 200: authentication setting device; 201: input reception unit; 202: information display unit; 203: authentication setting unit; 204: information storage unit; 205: communication unit; 206: setting screen display unit; 207: instrument selection unit; 208: type selection unit; 209: addition setting unit; 300: authentication execution device; 307: device communication unit; 308: collection unit; 309: authentication unit; 310: password authentication unit; 311: password storage unit; 312: authentication information generation unit; 313: authentication information storage unit; 314: control program storage unit; 315: control management unit; 316: authentication result storage unit; 400: communication path; 510: configuration information; 511: setting-use instrument attribute information; 512: instrument authentication information; 513: authentication-use instrument attribute information; 514: authentication target instrument information; 515: confirmation-use instrument attribute information; 520: log information; 901: computation device; 902: external storage device; 903: main storage device; 904: communication device; 905: input/output device

1. An instrument control system comprising an instrument control device to control an instrument, and a terminal device to communicate with the instrument control device,
the terminal device having a setting request unit to transmit a setting request requesting setting of instrument authentication information used for authentication of the instrument,
the instrument control device having:
an information setting unit to set, upon reception of the setting request from the setting request unit, the instrument authentication information to a storage device;
an authentication unit to acquire an authentication request requesting authentication of the instrument, and in response to the acquired authentication request, output a collection request requesting collection of instrument attribute information indicating an attribute of the instrument; and
a collection unit to collect, upon acquisition of the collection request, instrument attribute information indicating an attribute of the instrument of the time the collection request is acquired, and output the collected instrument attribute information,
the authentication unit acquiring the instrument attribute information outputted from the collection unit, as authentication-use instrument attribute information used for authentication of the instrument, authenticating the instrument based on the acquired authentication-use instrument attribute information and the instrument authentication information which is set by the information setting unit, and deciding whether or not authentication of the instrument is successful.

2. The instrument control system according to claim 1,
wherein the instrument setting unit, upon reception of the setting request from the setting request unit, outputs the collection request to the collection unit, acquires the instrument attribute information outputted from the collection unit, as setting-use instrument attribute information used for setting the instrument authentication information, and sets the acquired setting-use instrument attribute information, as the instrument authentication information.

3. The instrument control system according to claim 1,
wherein the instrument control device further has a control management unit which, when the authentication unit decides that authentication of the instrument fails, stops control for the instrument.

4. The instrument control system according to claim 1,
wherein the authentication unit decides, by a processing device, whether or not the authentication-use instrument attribute information agrees with the instrument authentication information, and if agreement is not found, decides that authentication of the instrument fails.

5. The instrument control system according to claim 4,
wherein, if it is decided that the authentication-use instrument attribute information does not agree with the instrument authentication information, the authentication unit stores, of the authentication-use instrument attribute information, information that does not agree with the instrument authentication information, to a storage device as disagreed information.

6. The instrument control system according to claim 5,
wherein the setting request unit transmits a confirmation request requesting confirmation of the instrument to the instrument control device, and
wherein the instrument control device further includes a device communication unit which, upon reception of the confirmation request from the setting request unit, outputs the collection request to the collection unit, acquires the instrument attribute information outputted from the collection unit, as confirmation-use instrument attribute information used for confirmation of the instrument, and transmits the acquired confirmation-use instrument attribute information and the disagreed information to the terminal device as a confirmation response to the confirmation request.

7. The instrument control system according to claim 6,
wherein the terminal device further has an information storage unit to store the instrument authentication information to the storage device, and
wherein, upon reception of the confirmation response from the device communication unit, the setting request unit, by the processing device, checks whether or not the confirmation-use instrument attribute information included in the confirmation response agrees with the instrument authentication information stored by the information storage unit; if it is decided that agreement is not found, checks whether or not, of the confirmation-use instrument attribute information, information that does not agree with the instrument authentication information, and the disagreed information included in the confirmation response agree; and if agreement is found, transmits, as the setting request, a request for setting the confirmation-use instrument attribute information to the instrument control device as the instrument authentication information.

8. The instrument control system according to claim 1,
wherein the instrument includes a plurality of instruments,
wherein the instrument control device controls the plurality of instruments, and
wherein the instrument attribute information includes connection information of connection between the instrument control device and each of the plurality of instruments.

9. The instrument control system according to claim 8, wherein the instrument attribute information includes instrument identification information that identifies each of the plurality of instruments.

10. The instrument control system according to claim 2,
wherein the instrument includes a plurality of instruments,
wherein the instrument control device controls the plurality of instruments,
wherein the terminal device further has an instrument selection unit which acquires a selected instrument which is selected from among the plurality of instruments,
wherein the setting request unit transmits a list of the selected instrument which is selected by the instrument selection unit, as a selected-instrument list together with the setting request, and
wherein the information setting unit extracts information indicating an attribute of the selected instrument included in the selected-instrument list, from the instrument attribute information outputted from the collection unit, acquires the extracted information indicating the attribute of the selected instrument, as setting-use instrument attribute information to be used for setting the instrument authentication information, and sets the acquired setting-use instrument attribute information, as the instrument authentication information.

11. The instrument control system according to claim 2,
wherein the terminal device further has a type selection unit which acquires a selected information type selected from an information type included in the instrument attribute information,
wherein the setting request unit transmits a list of the selected information type which is selected by the type selection unit, as a selected-information-type list together with the setting request, and
wherein the information setting unit extracts information of the selected information type included in the selected-information-type list, from the instrument attribute information outputted from the collection unit, acquires the information of the selected information type which is extracted, as the setting-use instrument attribute information to be used for setting the instrument authentication information, and sets the acquired setting-use instrument attribute information, as the instrument authentication information.

12. The instrument control system according to claim 1,
wherein the terminal device further has an addition setting unit which acquires addition permit/non-permit information indicating permit/non-permit of addition of an instrument to the instrument control device,
wherein the setting request unit transmits the addition permit/non-permit information acquired by the addition setting unit to the instrument control device together with the setting request, and
wherein the authentication unit, if the authentication-use instrument attribute information does not agree with the instrument authentication information, refers to the addition permit/non-permit information, and decides whether or not authentication of the instrument is successful based on a reference result.

13. An instrument control device which controls an instrument and communicates with a terminal device, the instrument control device comprising:
a device communication unit to receive a setting request requesting setting of instrument authentication information used for authentication of the instrument, from the terminal device;
an information setting unit to set, upon reception of the setting request by the device communication unit, the instrument authentication information to a storage device;
an authentication unit to acquire an authentication request requesting authentication of the instrument and output a collection request requesting collection of instrument attribute information indicating an attribute of the instrument; and
a collection unit to collect, upon acquisition of the collection request, instrument attribute information indicating an attribute of the instrument of the time the collection request is acquired,
the authentication unit acquiring the instrument attribute information outputted from the collection unit, as authentication-use instrument attribute information used for authentication of the instrument, authenticating the instrument based on the acquired authentication-use instrument attribute information and the instrument authentication information which is set by the information setting unit, and deciding whether or not authentication of the instrument is successful.

14. An instrument control method for an instrument control system including an instrument control device to control an instrument, and a terminal device to communicate with the instrument control device, the instrument control method comprising:
by the terminal device, transmitting a setting request requesting setting of instrument authentication information used for authentication of the instrument;
by the instrument control device, upon reception of the setting request from the terminal device, setting the instrument authentication information to a storage device;
by the instrument control device, acquiring an authentication request requesting authentication of the instrument, and in response to the acquired authentication request, outputting a collection request requesting collection of instrument attribute information indicating an attribute of the instrument;
by the instrument control device, collecting, upon acquisition of the collection request, instrument attribute information indicating an attribute of the instrument of the time the collection request is acquired, and outputting the collected instrument attribute information; and
by the instrument control device, acquiring the instrument attribute information as authentication-use instrument attribute information used for authentication of the instrument, authenticating the instrument based on the acquired authentication-use instrument attribute information and the instrument authentication information, and deciding whether or not authentication of the instrument is successful.

15. A non-transitory computer readable recording medium which stores a program for an instrument control device which controls an instrument and which communicates with a terminal device, the program causing a computer to execute:
an authentication setting process of receiving a setting request requesting setting of instrument authentication information used for authentication of the instrument, from the terminal device, and setting the instrument authentication information to a storage device;
a collection request output process of acquiring an authentication request requesting authentication of the instrument and outputting a collection request requesting collection of instrument attribute information indicating an attribute of the instrument;
a collection process of acquiring the collection request, collecting, in response to the acquired authentication request, instrument attribute information indicating an attribute of the instrument of the time the collection request is acquired, and outputting the collected instrument attribute information; and
an authentication process of acquiring the instrument attribute information outputted by the collection process, as authentication-use instrument attribute information used for authentication of the instrument, authenticating the instrument based on the acquired authentication-use instrument attribute information and the instrument authentication information which is set by the authentication setting process, and deciding whether or not authentication of the instrument is successful.
